(19) United States
(12) Patent Application Publication
(10) Pub. No.: US 2004/0211117 A1
(43) Pub. Date: Oct. 28, 2004

(54) Sowing method of the plant seeds and the sowing materials used thereof

(76) Inventors: Shih-Pan-Yu Hsieh, Taichung (TW); Rui-Zhi Huang, Taoyuan (TW)

Correspondence Address: Mathews, Collins, Shepherd & Gould, P.A., 100 Thanet Circle Suite 306, Princeton, NJ, 08540-3674, US

(21) Appl. No.: 09/885,140

(22) Filed: Jun. 20, 2001

(51) Int. Cl. A01G 1/00

(52) U.S. Cl. 47/58.1 SC

(57) ABSTRACT

A method of sowing plant seeds and the sowing materials used thereof are disclosed. The sowing method comprises the steps of a) providing a base with water-absorbing ability and humidity-maintaining ability, wherein the base includes a plurality of concavities, b) inlaying the plant seeds in the plural concavities of the base, and c) covering a cultivating material with the base, wherein each concavity has a void therein for allowing a radicle of a corresponding plant seed to pierce therethrough and be rooted in the cultivating material while the corresponding plant seed is germinating. The base comprises light-blocking material for preventing weeds from growing and is selected from a group consisting of a mulching paper, a fabric, a fiber and a polymer. Therefore, the steps of sowing, soil-covering and weed-removal for agricultural production can be proceeded simultaneously and thus lower cost.

### FIELD OF THE INVENTION

The present invention relates to a sowing method of plant seeds and the sowing materials used thereof, and more specifically to a sowing method of plant seeds inlayed in a weed-growth-preventing mulching paper and a weed-growth-preventing mulching paper used thereof.

### BACKGROUND OF THE INVENTION

In general, agricultural production comprises the steps of land-preparation, sowing, fertilization, hand weeding and harvest. Each step requires a huge amount of man power. In particular, hand weeding requires a huge amount of man power that ultimately results in delays in the following harvest.

Conventional weed removal methods require covering the land with a black plastic film to prevent weeds from growing. However, after the crops are harvested, black plastic film remains on the ground and contributes to environmental pollution. Accordingly, new methods of agricultural production are necessary for weed-removal and prevention which does not result in environmental pollution.

### SUMMARY OF THE INVENTION

An object of the present invention is to provide a sowing method for increasing the emergence percentage of plant seeds.

Another object of the present invention is to provide a sowing method for increasing the production amount of crops.

A further object of the present invention is to provide a method for simultaneously performing the steps of sowing, soil-covering and weed-removal for agricultural production.

In a first aspect, the present invention is related to a sowing method of plant seeds. The sowing method comprises the steps of: a) providing a base with water-absorbing ability and humidity-maintaining ability, wherein the base includes a plurality of concavities, b) inlaying plant seeds in the plural concavities of the base, and c) covering a cultivating material with the base, wherein each concavity has a void therein for allowing a radicle of a corresponding plant seed to pierce therethrough and be rooted in the cultivating material while the corresponding plant seed is germinating.

The base comprises light-blocking material for preventing weeds from growing and is selected from a group consisting of a mulching paper, a fabric, a fiber and a polymer with natural decomposing ability. Preferably, the base is a thin layer having a thickness ranging from 0.2 mm to 0.3 mm.

Each of the plural concavities is arranged in the base with a specific distance interval for effectively increasing the uniformity of nutrition absorption and the use of growth space of the plant seeds.

The method further includes using a securing layer to fix the plant seeds in the plural concavities of the base so as to induce the radicles of the plant seeds to be rooted in the cultivating material and increase the water-absorbing ability of the radicles of the plant seed.

The securing layer is either a toilet paper or a paper-made towel and is attached to the base for fixing the plant seeds by using an adhesive material.

The adhesive material is glue adapted to be uniformly sprayed on the base for attaching the securing layer to the base to fix the plant seeds.

The plant seeds are selected from a group consisting of the seeds of a cereal, a vegetable, a flower, a tree and a fruit.

In a second aspect, the present invention is related to a base with water-absorbing ability and humidity-maintaining ability for use in sowing plant seeds to cover a cultivating material therewith comprising a plurality of concavities for allowing the plant seeds to be inlaid therein, wherein each concavity has a void therein for allowing a radicle of a corresponding plant seed to pierce therethrough and be rooted in the cultivating material while a plant seed is germinating.

The base comprises light-blocking material for preventing weeds from growing and is selected from a group consisting of a mulching paper, a fabric, a fiber and a polymer with natural decomposing ability. Preferably, the base is a thin layer having a thickness ranging from about 0.2 mm to about 0.3 mm.

In a third aspect, the present invention is related to a mulching paper for use in sowing plant seeds to cover a cultivating material therewith comprising a plurality of concavities for allowing the plant seeds to be inlaid therein, wherein each concavity has a void therein for allowing a radicle of a corresponding plant seed to pierce therethrough and be rooted in the cultivating material while the corresponding plant seed is germinating.

### DETAILED DESCRIPTION OF THE PREFERRED EMBODIMENTS

The present invention is directed to a method of sowing plant seeds and the sowing materials used thereof. The sowing method comprises the steps of a) providing a base with water-absorbing ability and humidity-maintaining ability, wherein the base includes a plurality of concavities, b) inlaying plant seeds in the plural concavities of the base, and c) covering a cultivating material with the base, wherein each concavity has a void therein for allowing a radicle of a corresponding plant seed to pierce therethrough and be rooted in the cultivating material while the corresponding plant seed is germinating. The base comprises light-blocking material for preventing weeds from growing and is selected from a group consisting of a mulching paper, a fabric, a fiber and a polymer. Preferably, the base is a thin layer having a thickness ranging from 0.2 mm to 0.3 mm.

The present invention may best be understood by the following example which uses a mulching paper as a base.

A number of sites of the mulching paper are pressed therein with a specific distance interval for forming a plurality of concavities. Each concavity has a void therein for allowing a radicle of a corresponding plant seed to pierce therethrough and be rooted in the soil. Thereafter, plant seeds are inlaid in each of the plural concavities, respectively. Finally, glue is uniformly sprayed on the mulching paper for attaching the securing layer, toilet paper (made by YUEN FOONG YU PAPER MFG CO., LTD), to the mulching paper.

The toilet paper used herein is for fixing plant seeds, achieving the objective of soil-covering and inducing the radicles of the plant seeds to be rooted in the soil for absorbing water. Because the mulching paper used herein can prevent weeds from growing, the application of herbicides to control weeds is unnecessary, and environmental pollution can be avoided. Because of the good water-absorbing ability and humidity-maintaining ability of the mulching paper, adequate irrigation and fertilization will expectably increase the germination percentage of the plant seeds as long as the mulching paper is well attached to the surface of the cultivating soil. In addition, the concavities arranged in the mulching paper can spread the plants out uniformly and also increase the uniformity of nutrition absorption and the use of growth space by the plants. Accordingly, the present invention provides a method for simultaneously performing the steps of sowing, soil-covering and weed control for agricultural production, which ultimately reduces cost.

While the mulching paper is spread on the surface of soil in the field, an amount of soil is usually placed on the edge of the mulching paper to prevent the mulching paper from being blown away by the wind. However, the edge of the mulching paper is easily torn up by the wind. To obviate this problem, the edge of the mulching paper can be folded back to increase the strength of the edge of the mulching paper.

Experiment

Punching-plates were prepared in advance. The punching-plates were immobilized onto mulching papers (58×16 cm) for punching concavities in the mulching using nails. For one mulching paper, the distance interval for the punched concavities was 2 cm, which resulted in 244 concavities. Two hundred forty-four water convolvulus seeds or cabbage seeds were then inlaid in the concavities of the mulching papers. Glue was sprayed uniformly on the mulching papers, toilet paper or paper-made towels were attached to the mulching papers to secure the plant seeds. Thereafter, they were air-dried naturally, and the combination of the plant seeds with the mulching paper was complete. Finally, cultivation boxes (60×17×20 cm) including cultivating soil, were covered with the mulching papers. For comparison, a control group of directly sowed plant seeds was also prepared. After these groups were cultivated in the green-house for 21 days, the emergence percentage of the plant seeds, the fresh weight of the plants, the number of plants and the weed-controlling capability were measured. The results are shown in Tables 1 and 2.

Table 1 shows many differences between the emergence percentage of the plant seeds, the fresh weight of the plants, the number of plants and the weed-controlling capability between the cultivation of water convolvulus and the control group. The weed amount was 0.50 for the water convolvulus compared to 32.75 for the control group. In addition, the weed-controlling capability was 98.47%, which was much greater than that for the control group.

Table 2 shows many differences in the emergence percentage of the plant seeds, the fresh weight of the plants, the number of plants and the weed-controlling capability between the cabbage and the control group. For example, the weed amount was 1.67 for cabbage compared to 46.33 for the control group. Moreover, the weed-controlling capability was 96.40%, which was much greater than that for the control group.

In conclusion, the emergence percentage of the plant seeds, the fresh weight of the plants, the number of plants and the weed-controlling capability according to the present invention were much greater than those results from the control group of seeds directly sowed in the cultivating soil. Thus, the present invention provides a method for simultaneously performing the steps of sowing, soil-covering and weed-removal for agricultural production which lowers cost. Moreover, besides mulching paper, other kinds of materials, such as fabrics, fibers and polymers can also be used as the base with good water-absorbing ability and humidity-maintaining ability.

TABLE 1
The cultivation of the water convolvulus.

| | Water convolvulus¹ | | | | Weed- |
|---|---|---|---|---|---|
| | Emergence | Fresh | | Weed | controlling |
| Cultivation | percentage | weight | | amount | capability |
| results | (%) | (g) | Number | (g) | (%) |
| Water | 74.83a³ | 287.50a | 271.50a | 0.50b | 98.47 |
| convolvulus | | | | | |
| Control | 9.95b | 145.25b | 79.75b | 32.75a | 0.00 |
| Group | | | | | |

¹. The counted area is 0.10 square meter.
². All the data shown are average numbers of four specimens.
³. According to Duncan's multiple range test, p = 0.05.

TABLE 2
The cultivation of the cabbage.

| | Cabbage¹ | | | | Weed- |
|---|---|---|---|---|---|
| | Emergence | Fresh | | Weed | controlling |
| Cultivation | percentage | weight | | amount | capability |
| results | (%) | (g) | Number | (g) | (%) |
| Cabbage | 90.0a³ | 430.00a | 201.67a | 1.67b | 96.40 |
| Control | 75.44b | 211.67b | 126.00b | 46.33a | 0.00 |
| Group | | | | | |

¹. The counted area is 0.0928 square meter.
². All the data shown are average numbers of four specimens.
³. According to Duncan's multiple range test, p = 0.05.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

1. A sowing method of plant seeds, comprising the steps of:
a) providing a thin fabric base with water-absorbing ability, humidity-maintaining ability, and natural decomposing ability, wherein said thin fabric base has a thickness in a range from 0.2 mm to 0.3 mm, and comprises a plurality of concavities with a specific distance interval;
b) inlaying said plant seeds in said plurality of concavities of said thin fabric base and covering said plant seeds with a securing layer; and
c) covering a cultivating material with said thin fabric base, wherein each concavity has a void therein for allowing a radicle of a corresponding plant seed to pierce therethrough and be rooted in said cultivating material while said corresponding plant seed is germinating.

2. The method according to claim 1, wherein said thin fabric base comprises light-blocking material for preventing weeds from growing.

3. (cancelled)

4. (cancelled)

5. The method according to claim 1, wherein each of said plurality of concavities is arranged in said thin fabric base with said specific distance interval for effectively increasing the uniformity of nutrition absorption and the use of growth space of said plant seeds.

6. The method according to claim 1, wherein said securing layer is used to fix said plant seeds in said plurality of concavities of said thin fabric base so as to induce said radicles of said plant seeds to be rooted in said cultivating material and increase humidity-maintaining ability of said thin fabric base correspondingly.

7. (cancelled)

8. The method according to claim 6, wherein said securing layer is attached to said thin fabric base for securing said plant seeds by using an adhesive material.

9. The method according to claim 8, wherein said adhesive material is glue adapted to be uniformly sprayed on said thin fabric base for attaching said securing layer to said thin fabric base to fix said plant seeds.

10. The method according to claim 1, wherein said plant seeds are selected from a group consisting of the seeds of a cereal, a vegetable, a tree and a fruit.

11. A thin fabric base with a thickness in a range from 0.2 mm to 0.3 mm, water-absorbing ability, humidity-maintaining ability and natural decomposing ability for use in sowing plant seeds to cover a cultivating material therewith comprising a plurality of concavities with a specific distance interval for allowing said plant seeds to be inlaid therein, wherein each concavity has a void therein for allowing a radicle of a corresponding plant seed to pierce therethrough and be rooted in said cultivating material while a plant seed is germinating.

12. The thin base according to claim 11, wherein said thin fabric base comprises light-blocking material for preventing weeds from growing.

13. (cancelled)

14. (cancelled)

15. A mulching sheet with natural decomposing ability, water-absorbing ability, and humidity-maintaining ability for use in sowing plant seeds to cover a cultivating material therewith comprising a plurality of concavities with a specific distance interval for allowing said plant seeds to be inlaid therein, wherein each concavity has a void therein for allowing a radicle of a corresponding plant seed to pierce therethrough and be rooted in said cultivating material while said corresponding plant seed is germinating and said mulching sheet is made from fabric.
